(19) United States
(12) Patent Application Publication
(10) Pub. No.: US 2023/0140741 A1
(43) Pub. Date: May 4, 2023

(54) NON-RECIPROCAL CIRCUIT ELEMENT AND COMMUNICATION APPARATUS HAVING THE SAME

(71) Applicants: TDK Corporation, Tokyo (JP); TDK Dalian Corporation, Liaoning (CN)

(72) Inventors: Hidenori OHATA, Tokyo (JP); Kosuke Sato, Tokyo (JP); Hideyuki Sasaki, Tokyo (JP)

(21) Appl. No.: 17/976,340

(22) Filed: Oct. 28, 2022

(30) Foreign Application Priority Data
Oct. 29, 2021 (CN) 202111270567.7

(51) Int. Cl. H01P 1/32; H01F 7/02

(52) U.S. Cl. CPC H01P 1/32; H01F 7/02

(57) ABSTRACT

Disclosed herein is a non-reciprocal circuit element that includes a dielectric substrate having a through hole, a magnetic rotator accommodated in the through hole, and a permanent magnet that applies a magnetic field to the magnetic rotator. The magnetic rotator is supported by the dielectric substrate without contacting an inner wall of the through hole.

### BACKGROUND OF THE ART

### Field of the Art

The present disclosure relates to a non-reciprocal circuit element and a communication apparatus having the same and, more particularly, to a non-reciprocal circuit element having a structure in which a magnetic rotator is accommodated in a through hole formed in a dielectric substrate and a communication apparatus having such a non-reciprocal circuit element.

### Description of Related Art

A non-reciprocal circuit element such as an isolator or a circulator, which is a kind of a magnetic device, has a configuration in which a magnetic rotator and a permanent magnet are sandwiched between upper and lower yokes. Non-reciprocal circuit elements described in JP 2002-043808A, JP 09-321504A, and JP 11-234003A have a structure in which a magnetic rotator is accommodated inside a through hole formed in a dielectric substrate.

However, the present inventor's studies have revealed that contact of the magnetic rotator with the inner wall of the through hole increases an insertion loss.

### SUMMARY

One of the objectives of the present disclosure is to reduce insertion loss in a non-reciprocal circuit element having a structure in which a magnetic rotator is accommodated in a through hole formed in a dielectric substrate. Another object of the present disclosure is to provide a communication apparatus having such a non-reciprocal circuit element.

A non-reciprocal circuit element according to the present disclosure includes a dielectric substrate having a through hole, a magnetic rotator accommodated in the through hole, and a permanent magnet that applies a magnetic field to the magnetic rotator. The magnetic rotator is supported by the dielectric substrate without contacting the inner wall of the through hole.

A communication apparatus according to the present disclosure includes the above-described non-reciprocal circuit element.

As described above, according to the present disclosure, it is possible to reduce insertion loss in a non-reciprocal circuit element having a structure in which a magnetic rotator is accommodated in a through hole formed in a dielectric substrate.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view from the upper side illustrating the outer appearance of a non-reciprocal circuit element 1 according to an embodiment of the present disclosure;

FIG. 2 is a schematic perspective view from the lower side illustrating the outer appearance of the non-reciprocal circuit element 1;

FIG. 3 is a schematic perspective view illustrating a state where the lower yoke 40 is removed from the non-reciprocal circuit element 1;

FIG. 4 is a schematic perspective view illustrating a state where the permanent magnet 20 and upper yoke 30 are removed from the non-reciprocal circuit element 1;

FIG. 5 is a schematic perspective view of the dielectric substrate 10;

FIG. 6 is a schematic plan view for explaining the structure of the magnetic rotator M;

FIG. 7 is a schematic perspective view illustrating a state where the center conductor 81 is removed from the magnetic rotator M;

FIG. 8 is a schematic plan view for explaining the positional relation between the through hole 11a and magnetic rotator M; and

FIG. 9 is a graph for explaining the relation between a distance L between the magnetic rotator M and the inner wall of the through hole 11a and insertion loss; and

FIG. 10 is a block diagram illustrating the configuration of a communication apparatus 200 using the non-reciprocal circuit element according to the above embodiment.

### DETAILED DESCRIPTION OF THE EMBODIMENTS

Some embodiments of the present disclosure will be explained below in detail with reference to the accompanying drawings.

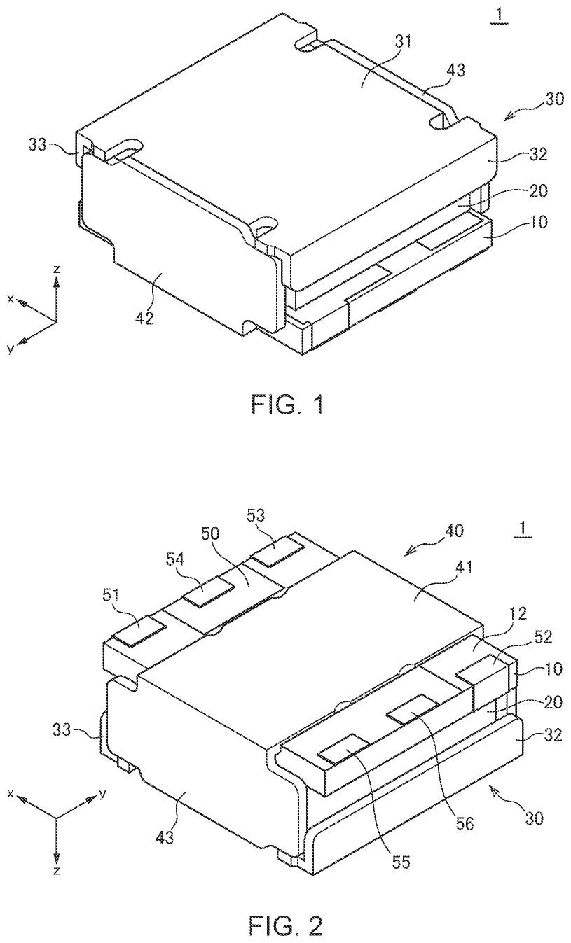

FIGS. 1 and 2 are schematic perspective views illustrating the outer appearance of a non-reciprocal circuit element 1 according to an embodiment of the present disclosure. FIG. 1 is a view from the upper side, and FIG. 2 is a view from the lower side.

The non-reciprocal circuit element 1 according to the present embodiment is a non-reciprocal circuit element of a surface mount type and includes, as illustrated in FIGS. 1 and 2, a dielectric substrate 10, a permanent magnet 20, an upper yoke 30, and a lower yoke 40. The dielectric substrate 10 and permanent magnet 20 are sandwiched between the upper and lower yokes 30 and 40. The dielectric substrate 10 has, on its lower surface 12, terminal electrodes 51 to 56 and a ground pattern 50. The upper yoke 30 has a top plate part 31 constituting the xy plane and folding parts 32 and 33 constituting the yz plane. The lower yoke 40 has a bottom plate part 41 constituting the xy plane and folding parts 42 and 43 constituting the xz plane. The folding parts 42 and 43 of the lower yoke 40 are fitted to the top plate part 31 of the upper yoke 30 to constitute a closed magnetic path.

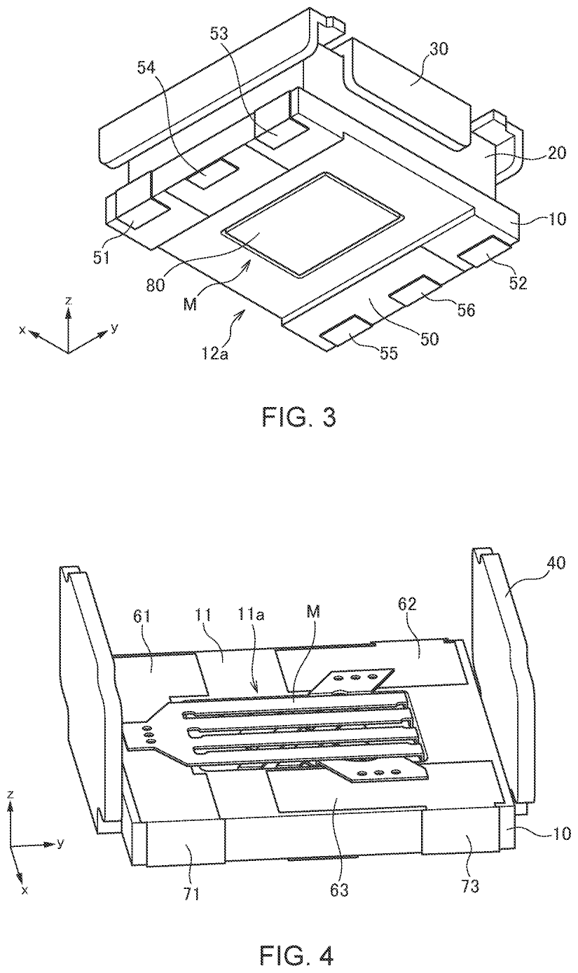

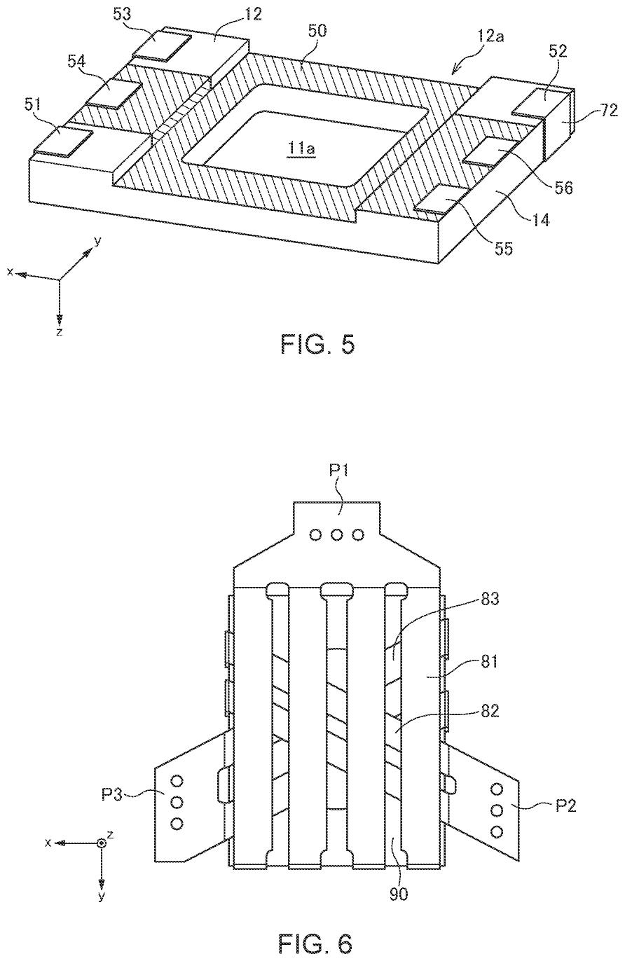

FIG. 3 is a schematic perspective view illustrating a state where the lower yoke 40 is removed from the non-reciprocal circuit element 1. FIG. 4 is a schematic perspective view illustrating a state where the permanent magnet 20 and upper yoke 30 are removed from the non-reciprocal circuit element 1. FIG. 5 is a schematic perspective view of the dielectric substrate 10.

As illustrated in FIGS. 3 to 5, the dielectric substrate 10 has upper and lower surfaces 11 and 12 constituting the xy plane, and a through hole 11a penetrates substantially the center portion of the dielectric substrate 10 in the z-direction. A magnetic rotator M is accommodated in the through hole 11a . An upper surface 11 of the dielectric substrate 10 is flat, while a lower surface 12 of the dielectric substrate 10 has a recessed part 12a extending in the y-direction, where the thickness of the dielectric substrate 10 is reduced. The bottom plate part 41 of the lower yoke 40 is accommodated in the recessed part 12a . This prevents the bottom plate part 41 of the lower yoke 40 from protruding from the lower surface 12 of the dielectric substrate 10.

Connection patterns 61 to 63 are provided on the upper surface 11 of the dielectric substrate 10. The connection patterns 61 to 63 are connected respectively to ports P1 to P3 of the magnetic rotator M. A part of each of the connection patterns 61 to 63 that overlaps the ground pattern 50 provided on the lower surface 12 serves also as a capacitance electrode of a capacitor. That is, the connection patterns 61 to 63 formed on the upper surface 11 of the dielectric substrate 10 and ground pattern 50 formed on the lower surface 12 of the dielectric substrate 10 constitute a capacitor pattern. The connection pattern 61 is connected to the terminal electrode 51 provided on the lower surface 12 of the dielectric substrate 10 through a connection pattern 71 provided on a side surface 13 of the dielectric substrate 10. The connection pattern 62 is connected to the terminal electrode 52 provided on the lower surface 12 of the dielectric substrate 10 through a connection pattern 72 provided on a side surface 14 of the dielectric substrate 10. The connection pattern 63 is connected to the terminal electrode 53 provided on the lower surface 12 of the dielectric substrate 10 through a connection pattern 73 provided on the side surface 13 of the dielectric substrate 10. The side surfaces 13 and 14 constitute the yz plane. The terminal electrodes 54 to 56 are connected to a ground conductor 80 included in the magnetic rotator M through the ground pattern 50 and the bottom plate part 41 of the lower yoke 40.

FIG. 6 is a schematic plan view for explaining the structure of the magnetic rotator M.

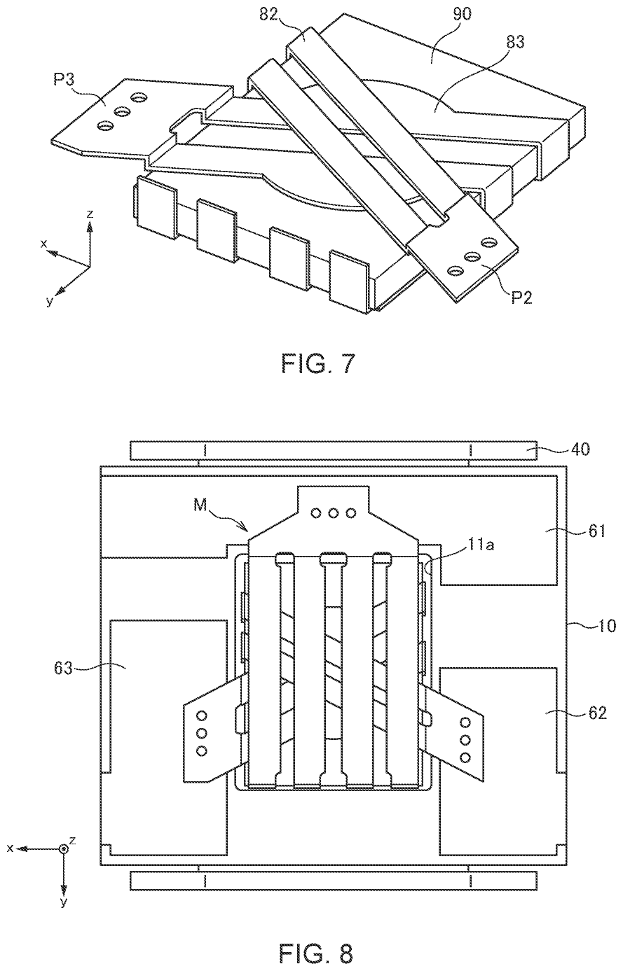

As illustrated in FIG. 6, the magnetic rotator M has center conductors 81 to 83 and a ferrite core 90. The center conductors 81 to 83 are each covered with an insulating film (which is omitted for easy understanding of the structure). FIG. 7 illustrates a state where the center conductor 81 is removed from the magnetic rotator M. The center conductors 81 to 83 are constituted by a plurality of metal conductors crossing one another at an angle of substantially 120°. In the example illustrated in FIGS. 6 and 7, the center conductor 81 is constituted by four metal conductors, and the center conductors 82 and 83 are each constituted by two metal conductors. The width of the center conductor 83 is enlarged at its center portion for characteristic adjustment, while the width of each of the center conductors 81 and 82 is constant. One ends of the center conductors 81 to 83 are connected respectively to the ports P1 to P3, and the other ends thereof are connected in common to the ground conductor 80 positioned on the back surface side of the ferrite core 90. As a result, the ferrite core 90 is sandwiched between the center conductors 81 to 83 and the ground conductor 80.

With the above configuration, the center conductor 81 is connected to the terminal electrode 51 through the connection patterns 61 and 71, the center conductor 82 is connected to the terminal electrode 52 through the connection patterns 62 and 72, and the center conductor 83 is connected to the terminal electrode 53 through the connection patterns 63 and 73. Further, the ground conductor 80 is connected to the terminal electrodes 54 to 56 through the bottom plate part 41 of the lower yoke 40 and the ground pattern 50.

FIG. 8 is a schematic plan view for explaining the positional relation between the through hole 11a and magnetic rotator M.

As illustrated in FIG. 8, the magnetic rotator M is supported by the dielectric substrate 10 without contacting the inner wall of the through hole 11a . That is, inside the through hole 11a , the magnetic rotator M is supported in a floating state. The reason why such a structure is adopted is that contact of the magnetic rotator M with the inner wall of the through hole 11a increases insertion loss.

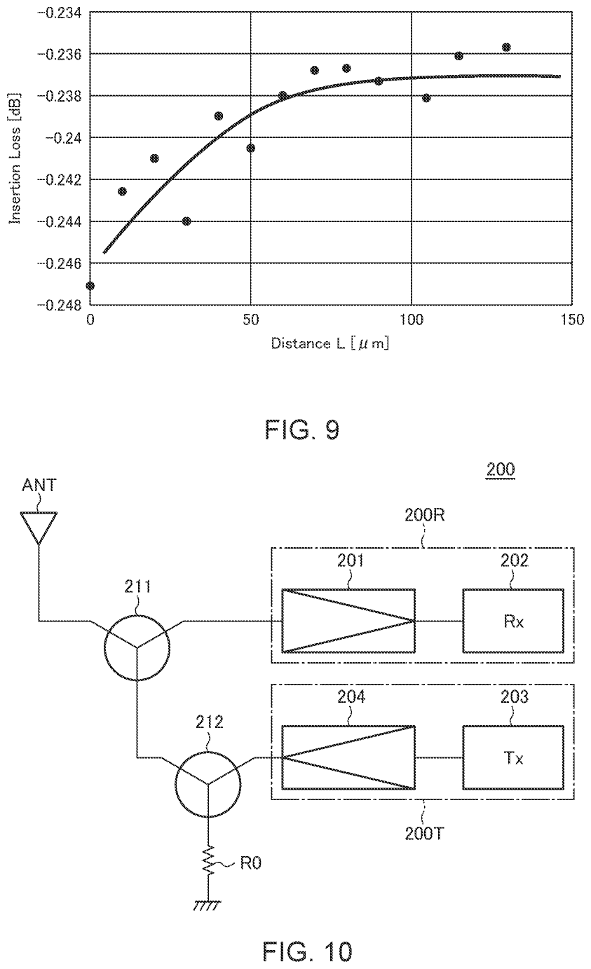

FIG. 9 is a graph for explaining the relation between a distance L between the magnetic rotator M and the inner wall of the through hole 11a and insertion loss.

As illustrated in FIG. 9, insertion loss decreases as the distance L between the magnetic rotator M and the inner wall of the through hole 11a increases. In particular, in an area where the distance L is 50 μm or less, the reduction effect of insertion loss due to an increase in the distance L is conspicuous. Considering this, the distance L may be 50 μm or more. Further, when the distance L becomes about 100 μm, the reduction effect of insertion loss due to an increase in the distance L substantially saturates. Considering this, the distance L may be 100 μm or more. Furthermore, when the distance L becomes about 150 μm, the reduction effect of insertion loss due to an increase in the distance L completely saturates. The distance L may be designed to be more than 150 μm; however, in this case, the planar size of the dielectric substrate 10 increases, or the effective area of the dielectric substrate 10 decreases, so that the distance L may be 150 μm or less.

The distance L may be constant over the entire periphery of the magnetic rotator M or may vary depending on the position. The reduction effect of insertion loss depends on the minimum distance between the magnetic rotator M and the inner wall of the through hole 11a , so that when there is a variation in the distance L, the distance L may be defined by the minimum distance thereof.

As described above, a part of each of the connection patterns 61 to 63 provided on the upper surface 11 overlaps the ground pattern 50 provided on the lower surface 12 in the z-direction. A capacitance component obtained by the overlap between the connection patterns 61 to 63 and the ground pattern 50 is utilized as a matching capacitance. This eliminates the need to mount a chip type matching capacitor on the dielectric substrate 10, thus making it possible to reduce the number of components. The matching capacitance can be adjusted by the shape or area of each of the connection patterns 61 to 63. Further, the dielectric substrate 10 and lower yoke 40 are separated members, so that it is not necessary to use a composite part which is required to be produced by an insert molding method.

In addition, in the present embodiment, the through hole 11a is formed in the dielectric substrate 10, and the magnetic rotator M is accommodated in the through hole 11a , thus making it possible to reduce the height of the non-reciprocal circuit element 1.

FIG. 10 is a block diagram illustrating the configuration of a communication apparatus 200 using the non-reciprocal circuit element according to the above embodiment.

A communication apparatus 200 illustrated in FIG. 10 is provided in, for example, a base station of a mobile communication system. The communication apparatus 200 includes a receiving circuit part 200R and a transmitting circuit part 200T which are connected to an antenna ANT adapted for data transmission and reception. The receiving circuit part 200R includes a reception amplification circuit 201 and a receiving circuit 202 for processing a received signal. The transmitting circuit part 200T includes a transmitting circuit 203 for generating an audio signal and a video signal and a power amplification circuit 204.

In the thus configured communication apparatus 200, non-reciprocal circuit elements 211 and 212 are inserted respectively into a path between the antenna ANT and the receiving circuit part 200R and a path between the transmitting circuit part 200T and the antenna ANT. The non-reciprocal circuit elements 211 and 212 may each be the non-reciprocal circuit element 1 according to the above embodiment. In the example illustrated in FIG. 10, the non-reciprocal circuit element 211 functions as a circulator, and the non-reciprocal circuit element 212 functions as an isolator having a terminal resistor R0.

While the one embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

A non-reciprocal circuit element according to the present disclosure includes a dielectric substrate having a through hole, a magnetic rotator accommodated in the through hole, and a permanent magnet that applies a magnetic field to the magnetic rotator. The magnetic rotator is supported by the dielectric substrate without contacting the inner wall of the through hole.

A communication apparatus according to the present disclosure includes the above-described non-reciprocal circuit element.

According to the present disclosure, the magnetic rotator does not contact the inner wall of the through hole, thus making it possible to reduce insertion loss.

In the present disclosure, the minimum distance between the magnetic rotator and the inner wall of the through hole may be 50 μm or more. This makes it possible to sufficiently reduce an insertion loss. Further, the minimum distance between the magnetic rotator and the inner wall of the through hole may be 100 μm or more. This allows the reduction effect of insertion loss to be exerted to the maximum extent. Further, the minimum distance between the magnetic rotator and the inner wall of the through hole may be 150 μm or less. This makes it possible to reduce insertion loss while sufficiently ensuring the effective area of the dielectric substrate.

The non-reciprocal circuit element according to the present disclosure may further include a connection pattern formed on the upper surface of the dielectric substrate and connected to the magnetic rotator, a terminal electrode formed on the lower surface of the dielectric substrate and connected to the connection pattern, and a ground pattern formed on the lower surface of the dielectric substrate, and a matching capacitance may be constituted by overlap between the connection pattern and the ground pattern, so that the lower surface of the dielectric substrate can be used as a mounting surface. This eliminates the need to use a composite part which is required to be produced by an insert molding method. Further, a capacitor pattern is provided in the dielectric substrate itself, eliminating the need to use a chip type matching capacitor, which makes it possible to reduce the number of components.

The non-reciprocal circuit element according to the present disclosure may further include upper and lower yokes sandwiching the dielectric substrate, magnetic rotator, and permanent magnet, and the lower surface of the dielectric substrate may have a recessed part accommodating a part of the lower yoke. This prevents interference between the lower yoke and a mounting substrate upon surface mounting.

As described above, according to the present disclosure, it is possible to reduce insertion loss in a non-reciprocal circuit element having a structure in which a magnetic rotator is accommodated in a through hole formed in a dielectric substrate.

What is claimed is:

1. A non-reciprocal circuit element comprising:
a dielectric substrate having a through hole;
a magnetic rotator accommodated in the through hole; and
a permanent magnet that applies a magnetic field to the magnetic rotator,
wherein the magnetic rotator is supported by the dielectric substrate without contacting an inner wall of the through hole.

2. The non-reciprocal circuit element as claimed in claim 1, wherein a minimum distance between the magnetic rotator and the inner wall of the through hole is 50 μm or more.

3. The non-reciprocal circuit element as claimed in claim 2, wherein a minimum distance between the magnetic rotator and the inner wall of the through hole is 100 μm or more.

4. The non-reciprocal circuit element as claimed in claim 2, wherein a minimum distance between the magnetic rotator and the inner wall of the through hole is 150 μm or less.

5. The non-reciprocal circuit element as claimed in claim 1, further comprising:
a connection pattern formed on an upper surface of the dielectric substrate and connected to the magnetic rotator;
a terminal electrode formed on a lower surface of the dielectric substrate and connected to the connection pattern; and
a ground pattern formed on the lower surface of the dielectric substrate,
wherein a matching capacitance is constituted by overlap between the connection pattern and the ground pattern.

6. The non-reciprocal circuit element as claimed in claim 5, further comprising upper and lower yokes sandwiching the dielectric substrate, magnetic rotator, and permanent magnet,
wherein the lower surface of the dielectric substrate has a recessed part accommodating a part of the lower yoke.

7. A communication apparatus including a non-reciprocal circuit element,
wherein the non-reciprocal circuit element comprising:
a dielectric substrate having a through hole;
a magnetic rotator accommodated in the through hole; and
a permanent magnet that applies a magnetic field to the magnetic rotator, and
wherein the magnetic rotator is supported by the dielectric substrate without contacting an inner wall of the through hole.
